(19) United States
(12) Patent Application Publication
(10) Pub. No.: US 2024/0140090 A1
(43) Pub. Date: May 2, 2024

(54) HEATING DEVICE AND INKJET RECORDING APPARATUS

(71) Applicant: KYOCERA Document Solutions Inc., Osaka (JP)

(72) Inventors: Takuma ARAKI, Osaka (JP); Yuna NIIMI, Osaka (JP); Junichi FUKUOKA, Osaka (JP); Susumu HANANO, Osaka (JP); Noriaki FURUKAWA, Osaka (JP)

(73) Assignee: KYOCERA Document Solutions Inc., Osaka (JP)

(21) Appl. No.: 18/500,069

(22) Filed: Nov. 1, 2023

(30) Foreign Application Priority Data
Nov. 2, 2022 (JP) 2022-176412

(51) Int. Cl. B41J 2/14; B41J 2/175

(52) U.S. Cl. CPC B41J 2/14088; B41J 2/14153; B41J 2/1752

(57) ABSTRACT

A heating device includes a tube, a container, a heater, and heat medium. The tube through which liquid flows is spirally formed. The container has a cylindrical part whose axial direction is along a spiral direction of the tube and stores the tube. The heater is provided in the cylindrical part. The heat medium is in liquid form and fills the container.

### INCORPORATION BY REFERENCE

This application is based on and claims the benefit of priority from Japanese patent application No. 2022-176412 filed on Nov. 2, 2022, which is incorporated by reference in its entirety.

### BACKGROUND

The present disclosure relates to a heating device and an inkjet recording apparatus.

The inkjet recording apparatus includes an ink container that supplies an ink to an inkjet head, but an ink supply device equipped with a large-capacity ink container is sometimes connected to the inkjet recording apparatus on the assumption that a large amount of ink is consumed. To achieve good image quality, the viscosity of the ink must be kept within a proper range. Therefore, the ink supply device is equipped with a heater to heat the ink. For example, a heater unit may include a metal plate, a tube in contact with the metal plate, and a linear heater provided along the tube with the metal plate in between and in contact with the metal plate.

However, in the above configuration, a plurality of the heaters is required because the tube includes straight portions provided parallel to each other. In addition, since a control part controls the heaters using the temperature measured by the temperature sensor for each section of the tube, a plurality of the temperature sensors is required and the control procedure is complicated. In addition, if cold ink suddenly flows into the tube, the temperature near the tube inlet drops suddenly. However, if the portion near the tube inlet may be heated to the target value, it is necessary to heat the portion locally and intensely, and overshoots may easily occur and the tube may be temporarily heated to a temperature higher than necessary.

### SUMMARY

A heating device according to the present disclosure includes a tube, a container, a heater, and heat medium. The tube through which liquid flows is spirally formed. The container has a cylindrical part whose axial direction is along a spiral direction of the tube and stores the tube. The heater is provided in the cylindrical part. The heat medium is in liquid form and fills the container.

An inkjet recording apparatus according to the present disclosure includes an ink storage part, the heating device, an inkjet head, and a conveyance part. The ink storage part stores an ink. The heating device heats the ink supplied from the ink storage part. The inkjet head ejects the ink heated by the heating device on a sheet. The conveyance part moves the inkjet head and the sheet relatively.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a perspective view showing an appearance of an image forming system according to one embodiment of the present disclosure.

FIG. 2 is a perspective view showing an appearance of an ink supply device according to the embodiment of the present disclosure.

FIG. 3 is a front view schematically showing an internal structure of the image forming system according to the embodiment of the present disclosure.

FIG. 4 is a diagram schematically showing an ink supply path according to the embodiment of the present disclosure.

FIG. 5 is a perspective view showing an appearance of a heating device according to the embodiment of the present disclosure.

FIG. 6 is a perspective view showing an internal structure of the heating device according to the embodiment of the present disclosure.

FIG. 7 is a perspective view showing a configuration of a tube according to the embodiment of the present disclosure.

FIG. 8 is a cross-sectional view of the heating device according to the embodiment of the present disclosure.

FIG. 9 is a cross-sectional view taken along the line I-I of FIG. 8.

FIG. 10 is a cross-sectional view showing the heating device according to a modified example of the embodiment of the present disclosure.

### DETAILED DESCRIPTION

Hereinafter, with reference to the attached drawings, an inkjet recording device 1 and an image forming system 100 according to one embodiment of the present disclosure will be described.

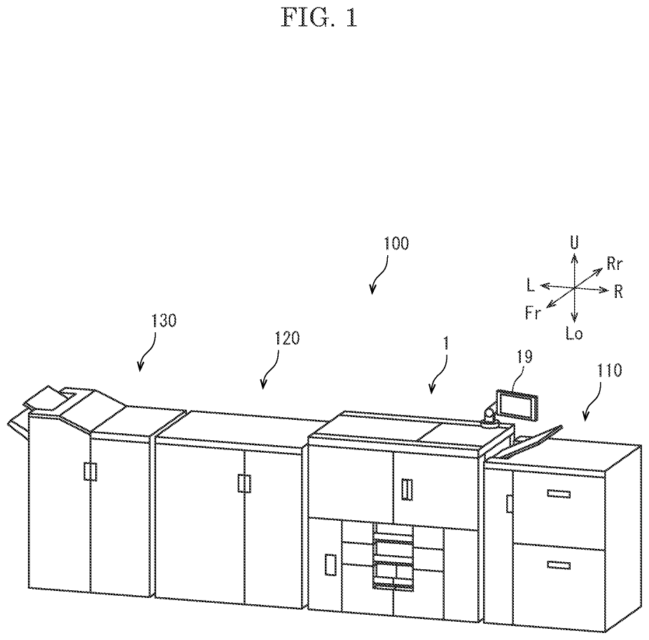

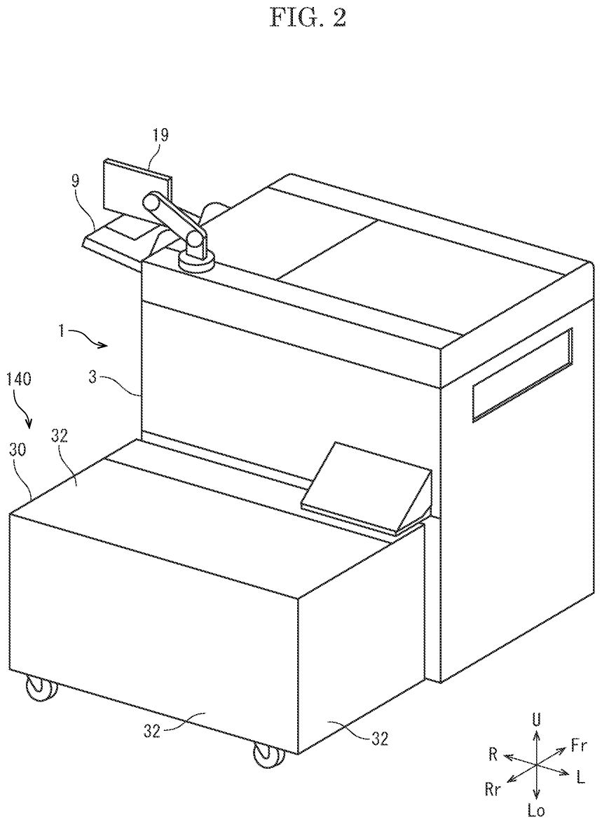

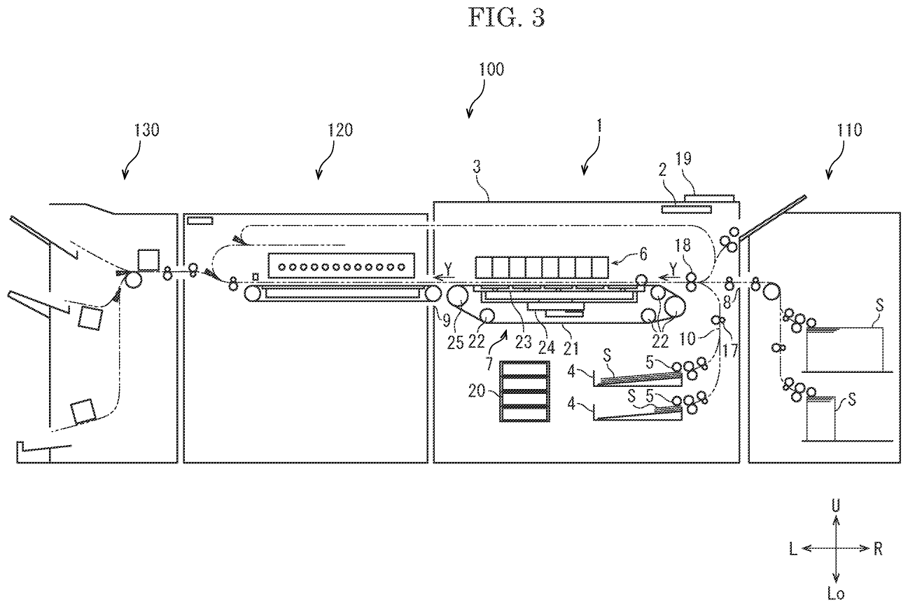

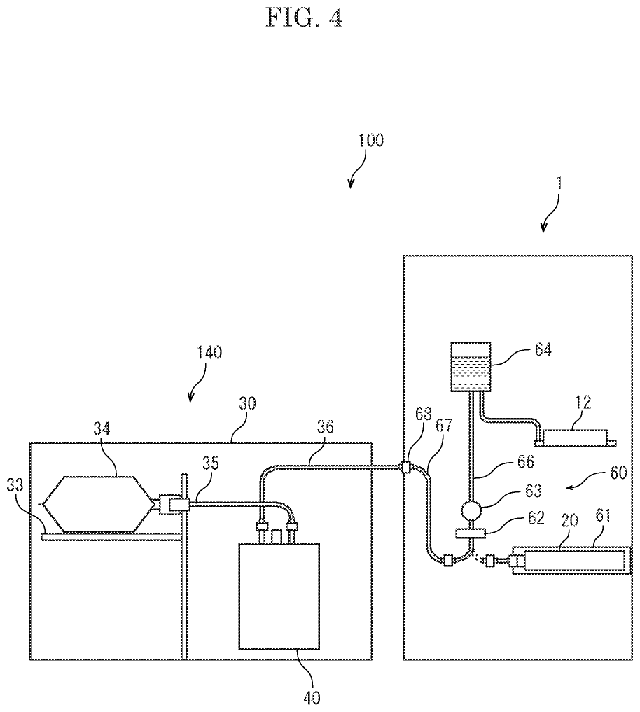

First, the entire structure of the image forming system 100 will be described. FIG. 1 s a perspective view showing the appearance of the image forming system 100. FIG. 2 is a perspective view showing the appearance of an ink supply device 140. FIG. 3 is a front view schematically showing the internal structure of the image forming system 100. FIG. 4 is a diagram schematically showing an ink supply path 60. Hereafter, the front side of the paper plan on which FIG. 1 is drawn is defined as the front side of the image forming system 100, and the left-and-right direction is described with reference to the direction in which the image forming system 100 is viewed from the front side. In each drawing, U, Lo, L, R, Fr and Rr indicate the upper, lower, left, right, front and rear, respectively.

The image forming system 100 (see FIG. 1 and FIG. 2) includes a sheet feeding device 110, an inkjet recording device 1, a drying device 120, a post-processing device 130, and an ink supply device 140. The sheet feeding device 110 includes a large-capacity sheet feeding unit that can store thousands of sheets S, and supplies the sheets S to the inkjet recording device 1. The ink supply device 140 is provided behind the inkjet recording device 1 and supplies an ink to the inkjet recording device 1. The inkjet recording device 1 forms an image on the sheet S by an inkjet method. The drying device 120 heats and dries the ink ejected on the sheet S. The post-processing device 130 performs post-processing such as punching, stapling and folding on the sheet S.

The inkjet recording device 1 (see FIG. 3) has a rectangular box-shaped body housing 3. In the lower part in the body housing 3, a sheet feeding cassette 4 in which the sheets S such as a plain paper, a coated paper, or the like are stored, and a sheet feeding roller 5 which feeds the sheets S from the sheet feeding cassette 4 are provided. Above the sheet feeding cassette 4, a conveying unit 7 is provided to attract the sheet S and convey it in the Y direction. Above the conveying unit 7, an image forming unit 6 is provided to form an image by ejecting the ink.

Inside the body housing 3, a conveyance path 10 is provided from the sheet feeding roller 5 through a gap between the conveying unit 7 and the image forming unit 6 to a discharge port 9. The conveyance path 10 is formed mainly by plate-like members facing each other with a gap for passing the sheet S. On the conveyance path 10, a conveyance roller 17 for holding and conveying the sheet S is provided. A registration roller 18 is provided upstream of the image forming unit 6 in the conveyance direction Y.

The conveying unit 7 includes an endless conveyance belt 21, a support plate 23, and a suction part 24. The conveyance belt 21 has a number of vent holes (not shown), and is wound around a drive roller 25 and a driven roller 22. The support plate 23 has a number of vent holes, and its upper surface is in contact with the inner surface of the conveyance belt 21. The suction part 24 attracts the sheet S to the conveyance belt 21 by sucking air through the vent holes of the support plate 23 and the vent holes of the conveyance belt 21. When the drive roller 25 is driven in the counterclockwise direction by a drive unit (not shown) including a motor and a reduction gear, the conveyance belt 21 travels in the counterclockwise direction, and the sheet S attracted to the conveyance belt 21 is conveyed in the Y direction.

The image forming unit 6 includes head units 11Y, 11Bk, 11C and 11M (collectively referred to as a head unit 11). The head unit 11 includes one or more inkjet heads 12, for example, three inkjet heads 12 arranged in a staggered manner. Ink containers 20Y, 20Bk, 20C, and 20M (collectively referred to as an ink container 20) filled with yellow, black, cyan, and magenta inks are connected to the head units 11Y, 11Bk, 11C, and 11M, respectively, through ink supply paths 60 (see FIG. 4).

FIG. 4 shows the ink supply path 60 corresponding to one color of the ink, but since four colors of the ink are used in this embodiment, four ink supply paths 60 are practically provided. The inkjet recording device 1 includes a container attachment part 61 to which the ink container 20 is attached, a filter 62 for filtering the ink, a pump 63 for pumping the ink from the ink container 20 through the filter 62, and a sub-tank 64 for storing the ink pumped from the pump 63. Although FIG. 4 shows one inkjet head 12, three inkjet heads 12 included in one head unit 11 are practically connected to one sub-tank 64.

The ink container 20, the filter 62, the pump 63 and the sub-tank 64 are connected by a main tube 66. One end of a relay tube 67 is connected to a coupling 68 provided on the rear surface of the body housing 3. When the ink supply device 140 is used, the upstream end of the main tube 66 is replaced by the other end of the relay tube 67 instead of the ink container 20.

A control part 2 (see FIG. 3) includes an arithmetic part and a storage part (not shown). The arithmetic part is, for example, a CPU (Central Processing Unit). The storage part includes storage media such as ROM (Read Only Memory), RAM (Random Access Memory) and EEPROM (Electrically Erasable Programmable Read Only Memory). The arithmetic part performs various processes by reading and executing the control program stored in the storage part. The control part 2 may be realized by an integrated circuit without using software.

A display operating part 19 is provided on the upper portion of the body housing 3 (see FIG. 1 to FIG. 3). The display operating part 19 is equipped with a display panel, a touch panel laminated on the display panel, and a keypad (not shown). The control part 2 displays a screen showing the operation menu, status, or the like of the inkjet recording device 1 on the display panel, and controls each part of the inkjet recording device 1 according to the operation detected by the touch panel and keypad.

The basic image forming operation of the inkjet recording device 1 is as follows. When an image forming job is input to the inkjet recording device 1 from the display operating part 19 or an external computer, the sheet feeding roller 5 feeds the sheet S from the sheet feeding cassette 4 to the conveyance path 10, and the registration roller 18, whose rotation is stopped, corrects the skew of the sheet S. When the registration roller 18 feeds the sheet S to the conveying unit 7 at a predetermined timing, the conveying unit 7 attracts the sheet S to the conveyance belt 21 and conveys it in the Y direction. When the control part 2 supplies the raster-type image data to the driving circuit in synchronization with the conveyance of the sheet S, the driving circuit supplies an ejection signal corresponding to the gradation of the image data to the pressurizing element, and the ink is ejected from the nozzle to form an image on the sheet S.

[Ink Supply Device] Next, the configuration of the ink supply device 140 will be described (see FIG. 2 and FIG. 4). The ink supply device 140 includes a housing 30, four attachment parts 33, four ink packs 34, and four heating devices 40.

The housing 30 includes a frame (not shown) in which metal columns, beams and the like are assembled in a rectangular box shape, and an exterior plate 32 (see FIG. 2) which forms the side and upper surfaces of the housing 30. The four attachment parts 33 are supported by the frame, and are aligned in the left-and-right direction in the upper portion inside the housing 30. Each of the four attachment parts 33 is fitted with the ink pack 34. One heating device 40 is provided for each of the ink packs 34.

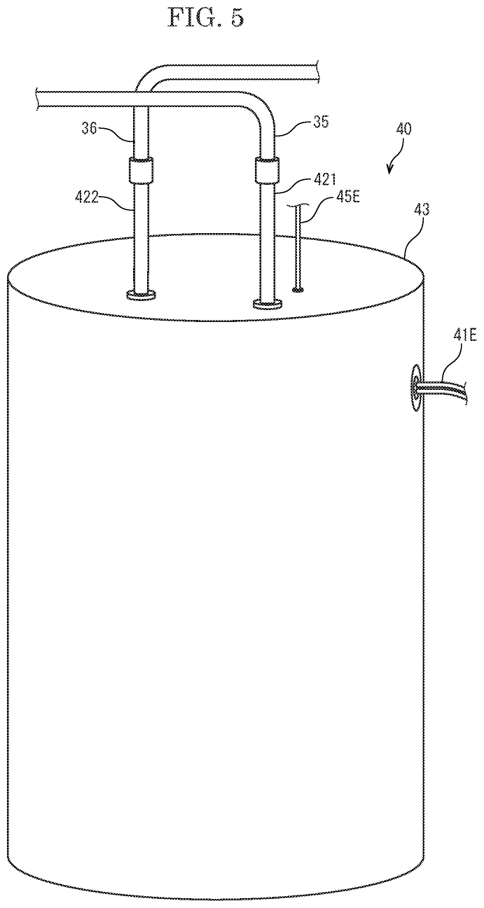

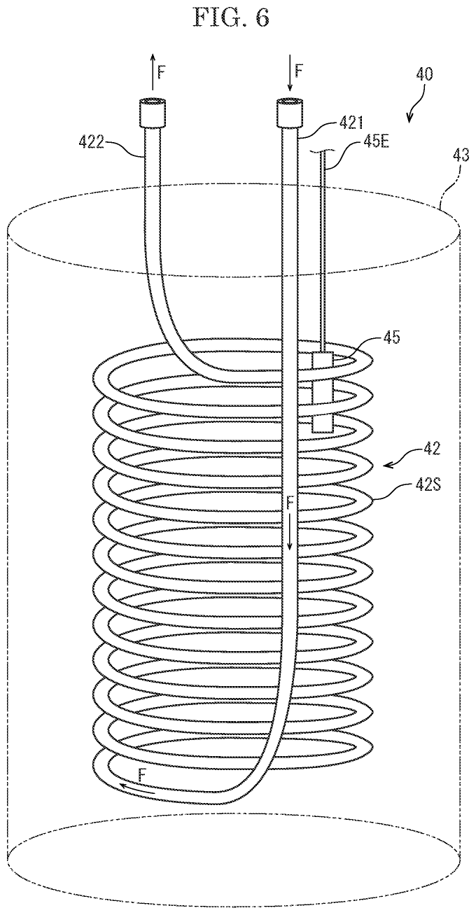

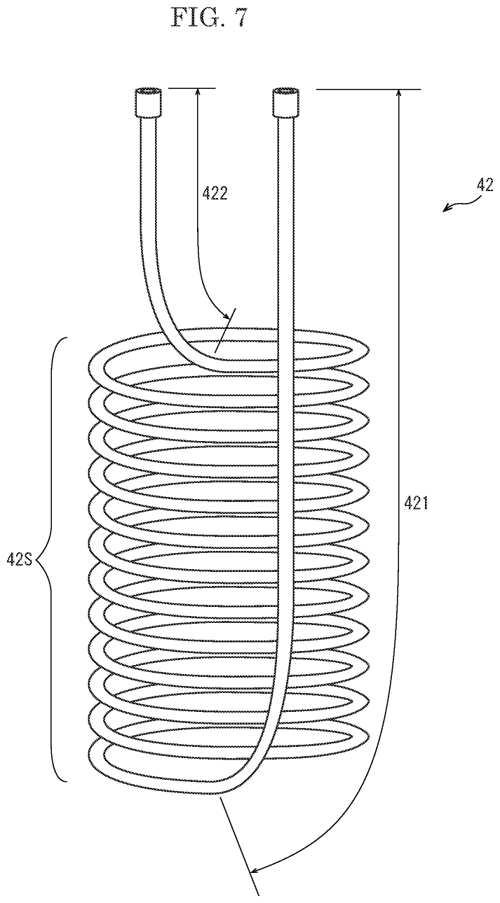

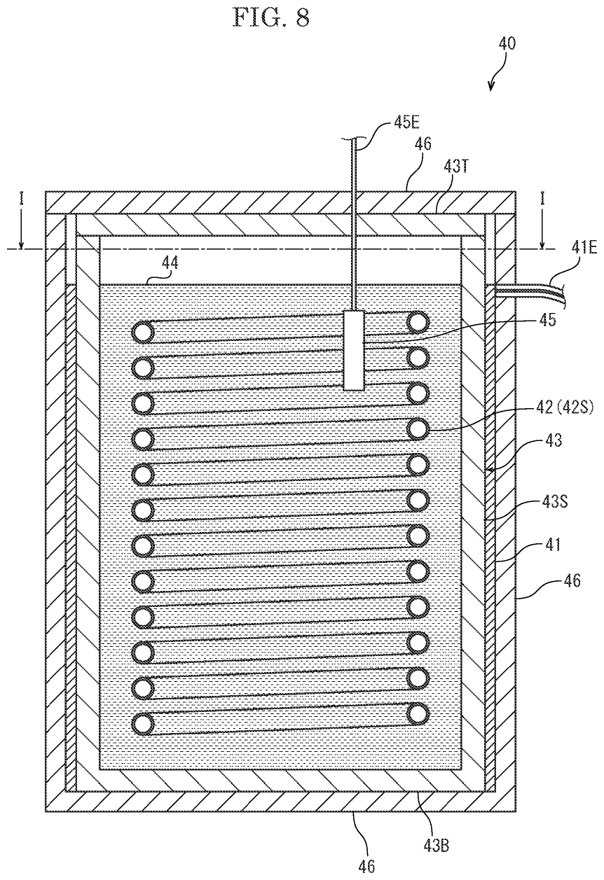

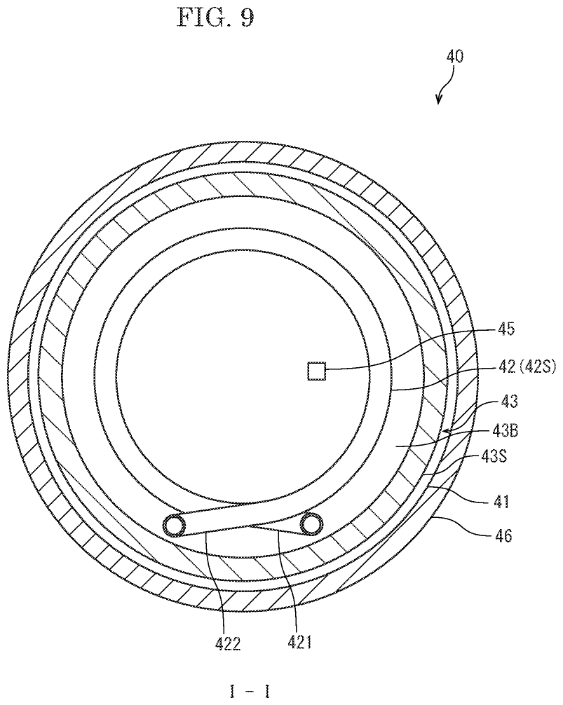

The ink pack 34 has a larger capacity than the ink container 20 mounted inside the inkjet recording device 1. Since four colors of the ink are used in this embodiment, the four ink packs 34 are provided and filled with the yellow, black, cyan and magenta inks, respectively.

[Heating device] Next, the configuration of the heating device 40 will be described. FIG. 5 is a perspective view showing the appearance of the heating device 40. FIG. 6 is a perspective view showing the internal configuration of the heating device 40. FIG. 7 is a perspective view showing the configuration of a tube 42. FIG. 8 is a cross-sectional view showing the heating device 40. FIG. 9 is a cross-sectional view taken along the line I-I of FIG. 8.

The heating device 40 according to the present embodiment includes a spirally formed tube 42, a container 43 having a cylindrical part 43S whose axial direction is along the spiral direction of the tube 42 and storing the tube 42, a heater 41 provided in the cylindrical part 43S, and a liquid heat medium 44 filling the container 43. Specifically, they are described as follows.

[Tube] The tube 42 (see FIG. 7) is, for example, formed by processing a straight tube with a circular cross section made of stainless steel into a spiral shape. The tube 42 is arranged such that the spiral axis direction is along the upper-and-lower direction. The tube 42 has a spiral portion 42S, a first extension portion 421 extending upward from the lower end of the spiral portion 42S, and a second extension portion 422 extending upward from the upper end of the spiral portion 42S. The ends of the first extension portion 421 and the second extension portion 422 are aligned with one side (the upper side in this example) of the spiral axis direction of the spiral portion 42S. A relay tube 35 is connected to the first extension portion 421, and a relay tube 36 is connected to the second extension portion 422.

[Container] The container 43 (see FIG. 5, FIG. 8 and FIG. 9) has the cylindrical part 43S whose axial direction is along the upper-and-lower direction, a circular bottom part 43B that closes the lower portion of the cylindrical part 43S, and a circular upper plate part 43T that closes the upper portion of the cylindrical part 43S. The outer surface of the container 43 is covered with a heat insulator 46 over the entire area. The first extension portion 421 and the second extension portion 422 of the tube 42 are exposed upward from a hole provided in the upper plate part 43T. The tube 42 is supported by the upper plate part 43T.

[Heater] The heater 41 (see FIG. 8 and FIG. 9) is provided between the cylindrical part 43S and the heat insulator 46. The heater 41 is, for example, a sheet-shaped heater in which an electric heating wire is covered with an aluminum sheet. The feeder line 41E feeding the heater 41 is exposed on the lateral side through the heat insulator 46.

[Heat Medium] The heat medium 44 is water. The liquid level of the heat medium 44 is located above the uppermost of the spiral portion 42S of the tube 42. That is, all the spiral portion 42S is immersed in the heat medium 44.

[Temperature sensor] A temperature sensor 45 is provided at a position where it is not in contact with either the heater 41 or the tube 42 in the heat medium 44. In this embodiment, the temperature sensor 45 is provided near the liquid level inside the spiral portion 42S. The signal line 45S of the temperature sensor 45 is exposed upward from the hole provided in the upper plate part 43T. The temperature sensor 45 is supported by the upper plate part 43T via the signal line 45S. The temperature sensor 45 measures the temperature of the heat medium 44 and outputs a signal indicating the temperature of the heat medium 44 to the control part 2.

[Control Part] The control part 2 (see FIG. 3) controls the heater 41 according to the temperature indicated by the signal output from the temperature sensor 45. For example, the electric power supplied to the heater 41 is adjusted so that the temperature of the heat medium 44 is maintained within a predetermined range. It should be noted that the control part 2 provided inside the ink supply device 140 separately from the control part 2 may be configured to control the heater 41.

The inkjet recording device 1 may include the ink supply device 140. In such a case, the inkjet recording device 1 includes an ink storage part for storing the ink, the heating device 40 for heating the ink supplied from the ink storage part, the inkjet head 12 for ejecting the ink heated by the heating device 40 to the sheet S, and a conveying part for relatively moving the inkjet head 12 and the sheet S. In this embodiment, the ink housing part is the ink pack 34 and the conveyance part is the conveying unit 7.

Next, the operation of the heating device 40 will be described (see FIG. 4 and FIG. 5). The ink stored in the ink pack 34 is pumped by the pump 63 and supplied to the inkjet recording device 1 through the relay tube 35, the heating device 40 and the relay tube 36 in order. In the heating device 40 (see FIG. 6), the ink passes through the first extension portion 421, the spiral portion 42S, and the second extension portion 422, in order (in the F direction in FIG. 6). For the tube 42, heat is applied from the heater 41 through the heat medium 44. The ink flows from the lower side to the upper side through the spiral portion 42S. When the temperature of the ink is compared between the lower portion and the upper portion of the inside of the spiral portion 42S, the temperature of the ink becomes higher at the upper portion because the ink at the upper portion receives the heat from the heater 41 longer than the ink at the lower portion. Therefore, the temperature sensor 45 measures the temperature of the heat medium 44 in the region where the temperature is highest.

In this embodiment, since the heater 41 is provided to surround the spiral portion 42S, heat loss is reduced and heating is efficiently performed. In addition, since the heater 41 is provided in the cylindrical part 43S, it is possible to arrange the spiral portion 42S and the heater 41 so as to be equally distant each other over the entire circumference, the heat can be uniformly applied from the heater 41 to the entire spiral portion 42S.

In addition, the heating device 40 according to the present embodiment does not have a configuration in which the tube is locally heated by the linear heater as in Patent Document 1, but heats the entire tube 42 through the heat medium 44, so that the temperature of the entire ink gradually rises and excessive temperature rise due to overshoot can be suppressed. In addition, even for an ink whose an upper limit temperature and heating rate are limited to stabilize a physical property, stable heating is possible with simple control. In addition, since there is little variation in temperature depending on places, a high-precision temperature control is possible without measuring the temperatures at multiple locations.

In addition, the heating device 40 according to this embodiment can heat in a small capacity container 43 compared with the configuration in which the linear heater is arranged along the linear tube as in Patent Document 1, and is excellent in space saving. Moreover, since there are many general-purpose products available for the tube 42 and the heater 41 according to the present embodiment, the device can be constructed at a low cost by utilizing them.

The heating device 40 according to the present embodiment described above includes the spirally formed tube 42, the container 43 having the cylindrical part 43S whose axial direction is along the spiral axis direction of the tube 42 and storing the tube 42, the heater 41 provided in the cylindrical part 43S, and the liquid heat medium 44 filling the container 43. With this configuration, stable heating can be efficiently performed by simple control in a space-saving and low-cost configuration.

According to the heating device 40 according to the present embodiment, the cylindrical part 43S is cylindrical. According to this configuration, the spiral portion 42S and the heater 41 can be arranged so as to be equally distant each other over the entire circumference, so that the heat can be uniformly applied from the heater 41 to the entire spiral portion 42S.

In addition, according to the heating device 40 according to the present embodiment, the temperature sensor 45 is provided at a position in the heat medium 44 where it does not come into contact with either the heater 41 or the spiral tube 42. With this configuration, the temperature of the heat medium 44 can be measured accurately.

In addition, according to the heating device 40 according to the present embodiment, the control part 2 is provided to control the heater 41 according to the temperature measured by the temperature sensor 45. With this configuration, the heater 41 can be controlled according to the temperature of the heat medium 44.

In addition, according to the heating device 40 according to the present embodiment, the cross section of the tube 42 is circular. With this configuration, temperature unevenness in the tube 42 can be suppressed.

In addition, according to the heating device 40 according to the present embodiment, the heat insulator 46 covering the container 43 is provided. With this configuration, heat loss can be suppressed.

In addition, according to the inkjet recording device 1 of this embodiment, the sub-tank 64 is arranged between the inkjet head 12 and the heating device 40. According to this configuration, when the ink in the heating device 40 is not within the predetermined temperature range suitable for printing, the supply of the ink from the heating device 40 to the sub-tank 64 is temporarily stopped, and while the ink in the heating device 40 is heated, the ink can be supplied from the sub-tank 64 to the inkjet head 12 to continue the image forming.

The above embodiment may be modified as follows.

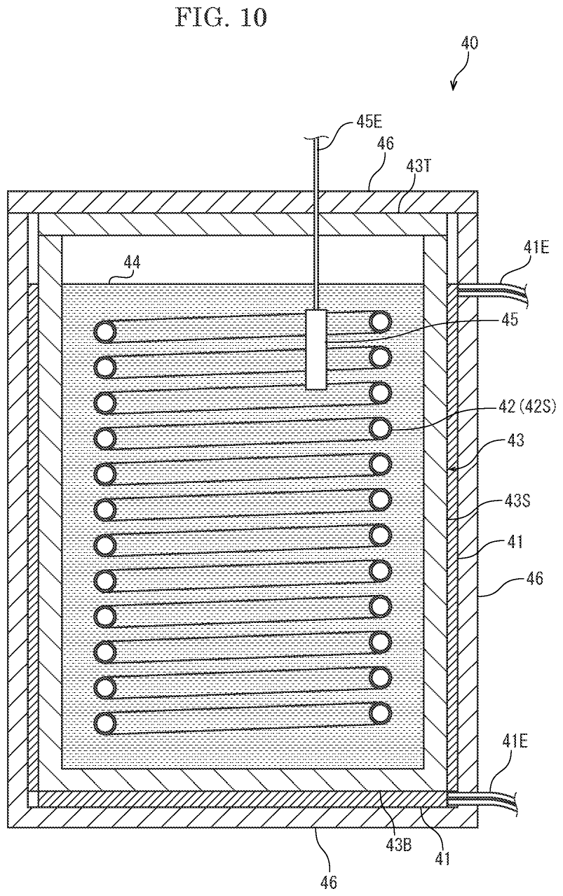

FIG. 10 is a cross-sectional view showing the heating device 40 according to a modified example. In the above embodiment, the heater 41 is provided only in the cylindrical part 43S, but in this modified example, the heater 41 is provided in the cylindrical part 43S and the bottom part 43B. With this configuration, heating can be performed with higher efficiency than in the above embodiment.

Thee above embodiment shows an example in which the temperature sensor 45 is provided inside the spiral portion 42S, but the temperature sensor 45 may be provided between the cylindrical part 43S and the spiral portion 42S of the container 43.

The above embodiment shows an example in which one temperature sensor 45 is provided, but multiple temperature sensors 45 may be provided. For example, the temperature sensors 45 may be provided at multiple locations in the circumferential direction inside the spiral portion 42S.

The above embodiment shows an example in which the cross-sectional shape of the tube 42 is circular, but the cross-sectional shape of the tube 42 may be oval or the like.

The above embodiment shows in example in which the heat medium 44 is water, but the heat medium 44 may be a liquid other than water (for example, oil) or a powder and granule (for example, sand).

In addition to the configuration of the above embodiment, a stirring device may be provided in the container 43. For example, a propeller rotating around an axis extending in the upper-and-lower direction may be provided between the bottom part 43B of the container 43 and the tube 42.

The above embodiment shows an example in which the heating device 40 is provided in the ink supply device 140, but the heating device 40 may be provided between the sub-tank 64 of the inkjet recording device 1 and the inkjet head 12. When the inkjet recording device 1 is not provided with the sub-tank 64, the heating device 40 may be provided between the ink container 20 and the inkjet head 12.

The above embodiment shows an example in which the ink flows through the spiral portion 42S from the lower side to the upper side, but the ink may flow through the spiral portion 42S from the upper side to the lower side.

The above embodiment shows an example in which the container 43 is cylindrical, but the container 43 may be rectangular or otherwise. In the case of a rectangular cylinder, the cross-sectional shape may preferably have a shape close to a cylinder such as a hexagonal or an octagonal.

The above embodiment shows an example in which the tube 42 is arranged such that its spiral axis direction is along the upper-and-lower direction, but the tube 42 may be arranged in a direction other than the upper-and-lower direction, for example, a direction inclined to the upper-and-lower direction (including the horizontal direction). In this case, the cylindrical part 43S is also arranged such that its axial direction is along the spiral direction.

1. A heating device comprising:
a spirally formed tube through which liquid flows;
a container having a cylindrical part whose axial direction is along a spiral direction of the tube and storing the tube;
a heater provided in the cylindrical part; and
a heat medium being in liquid form and filling the container.

2. The heating device according to claim 1, wherein
the cylindrical part has a circular cylindrical shape.

3. The heating device according to claim 1, wherein
a spiral portion of the heater and the cylindrical part are disposed to be equally distant each other.

4. The heating device according to claim 1, wherein
the tube is disposed such that the spiral direction is along an upper-and-lower direction, and
the heater is provided in the cylindrical part and a bottom part of the container.

5. The heating device according to claim 1, comprising:
a temperature sensor provided at a position where it is not in contact with either the heater or the tube in the heat medium.

6. The heating device according to claim 1, wherein
the liquid flows in the tube from a lower side to an upper side, and
the temperature sensor is arranged near a liquid level of the heat medium.

7. The heating device according to claim 1, comprising:
a control part controlling the heater according to a temperature measured by the temperature sensor.

8. The heating device according to claim 1, wherein
a cross-sectional shape of the tube is circular.

9. The heating device according to claim 1, comprising:
a heat insulator covering the container.

10. An inkjet recording apparatus comprising:
an ink storage part in which ink is stored;
the heating device according to claim 1, the heating device heating the ink supplied from the ink storage part;
an inkjet head ejecting the ink heated by the heating device on a sheet; and
a conveyance part which moves the inkjet head and the sheet relatively.
